(19) United States
(12) Patent Application Publication
(10) Pub. No.: US 2008/0138472 A1
(43) Pub. Date: Jun. 12, 2008

(54) High fiber rotary molded cookies containing inulin and resistant starch

(76) Inventor: Deise Alexandre, Piracicaba (BR)

Correspondence Address: GREENBLUM & BERNSTEIN, P.L.C., 1950 ROLAND CLARKE PLACE, RESTON, VA, 20191, US

(21) Appl. No.: 11/637,589

(22) Filed: Dec. 12, 2006

(51) Int. Cl. A21D 10/00; A23P 1/10

(52) U.S. Cl. 426/104; 426/549

(57) ABSTRACT

High fiber cookies containing inulin are produced using rotary molding to achieve a variety of shapes while avoiding inulin lumping and excessive dough stickiness and mold release problems by replacing a substantial portion of the inulin with a resistant starch. The rotary molded cookies have a fiber content derived from the inulin and resistant starch of at least about 7% by weight, possess well-defined embossing and imprinting, exhibit at least substantial homogeneity in color and texture and are at least substantially devoid of undesirable dark spots caused by insufficient dispersion or lumping of inulin. A softer, but crisp texture, calorie reduction, shortening or fat content reduction, and sugar content reduction may also be achieved with the combination of inulin and resistant starch. The rotary molded cookies may be in the form of matching faces and bodies thereby providing play value as well as a healthier product for children.

### FIELD OF THE INVENTION

This invention relates to the production of high fiber rotary molded cookies which contain inulin and resistant starch. This invention also relates to rotary molded cookies and doughs with molded shapes to appeal to children and which have significantly low calorie, fat, and sugar contents and substantial fiber contents.

### BACKGROUND OF THE INVENTION

The addition of a high amount of fiber to foods, particularly cookies, while maintaining organoleptic properties, and cookie spread in the case of cookies, is a challenge. Inulin and resistant starch are sources of fiber which may provide a good nutritional profile and health benefits if incorporated into cookies. Inulin is a soluble fiber which has prebiotic properties. Resistant starch is also a prebiotic fiber which helps maintain colon health, and also is a source of dietary fiber that improves digestive health. Use of only inulin as a source of fiber, was found to result in dispersion problems during mixing to form a dough. Dispersion of the fibers is difficult due to the hygroscopic properties of the fiber and the large amount of the fibers, resulting in lump formation. For example, when inulin is added in the creaming stage, the inulin acts as a gelling agent when dispersed and hydrated in water. If there is not enough water to hydrate the high amount of inulin added, lumps form during the mixing procedure. Increasing the amount of water to eliminate lumping may adversely affect dough machinability and can deleteriously increase baking times. Increasing mixing times were not found to satisfactorily eliminate the lumping problem. Also, after baking, the cookies presented dark color spots because of the presence inulin lumps. Therefore, the high amount of inulin, the hygroscopicity of the inulin, and the low amount of available water were three factors, that when combined, prohibited the addition of inulin in the first stage of mixing. Addition of the inulin over the wheat flour in the second stage has also been found to result in lumping of the inulin.

Use of a preblend of wheat flour and inulin obtained using a powder mixer helps to substantially eliminate lumps in the dough. However, the dough does not provide very good performance during molding, because the dough is a bit sticky. It may not conform to the rotary mold well to provide high definition shapes, and may exhibit mold release problems. In addition, cookies produced with only inulin have been found to present a slightly undesirable aftertaste, a harder texture and a little too dark in color.

It has also been found that as the amount of resistant starch incorporated into a cookie increases, the cookie texture tends to become too soft, and the cookie flavor tends to become too starchy providing a starchy aftertaste. Depending on the amount used, the resistant starch provides too soft a texture and a “starchy” flavor (aftertaste).

Another source of fiber which may be employed in foods is polydextrose. However, it has been found that cookies prepared with polydextrose tend to be too hard and fragile and exhibit excessive spread during baking. Also, employing large amounts of polydextrose to increase fiber content may result in a laxative effect in sensitive individuals. Bullock et al, “Replacement of Simple Sugars in Cookie Dough,” Food Technology, pp. 82-85 (January 1992) and Zoulias et al, “Effect of Sugar Replacement by Polyols and Acesulfame-K on Properties of Low-Fat Cookies,” J. Sci. Food Agric., 80:2049-2056 (2000), disclose that polydextrose has been proposed as a bulking agent for sugar or fat replacement in cookies. The Bullock et al objective was to develop a sugar-free cookie. They used sweeteners instead of sugar and they used polydextrose and insoluble fibers as a bulking agent. According to Zoulias et al, replacement of up to 35% of fat results in products with acceptable textural and sensory properties, but they are harder than the full fat cookies. Zoulias et al studied the effect of sugar replacement by polyols in cookies that contain polydextrose as a substitute for 35% of the fat content and found that lactitol and sorbitol improved the texture of low-fat cookies, making them softer and less brittle, but lower in sweetness.

In another article, Zoulias et al, “Effect of Fat and Sugar Replacement on Cookie Properties,” J. Sci. Food Agric., 82:1637-1644 (2002), it is disclosed that inulin (Raftiline) and polydextrose (Litesse) were tested as potential fat replacers in cookies. Cookies prepared with polydextrose (35% of fat replaced) were significantly harder than the control and other fat-reduced samples. On the other hand, cookies prepared with inulin presented similar hardness. However, both of them, especially at 50% of fat replaced, had significantly lower flavor, insufficient spread, and lower general acceptance scores than the control cookies.

Devereux et al, “Consumer Acceptability of Low Fat Foods Containing Inulin and Oligofructose,” J. Food Science, vol. 66, No. 5, pp. 1850-1854 (2003) studied the addition of inulin and oligofructose as fat replacers in some products. Anzac cookies were prepared using inulin. The Anzac cookie was rated significantly lower than the full-fat product, particularly in terms of texture.

Gallagher et al, “Use of Response Surface Methodology to Produce Functional Short Dough Biscuits,” J. Food Eng., 56:269-271 (2003) discloses the production of functional short dough biscuits using Raftilose (sugar replacer/fructooligosaccharide), Simplesse (protein based fat replacer), Novelose 330 (resistant starch), and sodium caseinate (dairy protein). Optimum ingredient levels were found to be 14% Novelose 330, 14.5% sodium caseinate, 25% Raftilose, and 25% Simplesse Dry, based upon flour addition. It was found that all trials produced biscuits that were significantly thicker than the control.

None of these references disclose the production of high fiber content molded cookies, or the use of a rotary molder which allows the production of different molding designs on a mass production basis.

U.S. Pat. Nos. 6,013,299, 6,352,733, and 6,613,373, and U.S. patent application Publication No. U.S. 2004/0047963 A1 each to Haynes et al disclose starch-based compositions which include a high-melting resistant starch type III having an endothermic melting peak of at least 140° C., exhibit unexpectedly superior baking characteristics, such as enhanced cookie spread, golden brown color, pleasant aroma, and surface cracking, which are comparable to those achieved with conventional wheat flour. The Haynes et al cookie doughs may contain polydextrose and may be rotary molded.

The present invention provides a process for eliminating lump formation and improving molding performance in the production of high fiber content cookies containing inulin. Cookies produced in accordance with the present invention exhibit excellent cookie spread, homogeneity in color and texture, with no starchy aftertaste or undesirable dark spots, and exhibit a crisp, not hard and not too soft texture. The high fiber cookies of the present invention may be mass produced using rotary molding to achieve a variety of shapes with interesting and amusing embossing or imprinting, without mold release problems caused by excessive dough stickiness.

### SUMMARY OF THE INVENTION

Lump formation is eliminated and molding performance is improved in the production of high fiber content cookies containing inulin by replacing a portion of the inulin with resistant starch. The addition of resistant starch and the reduction of the amount of inulin also improves dispersion of the inulin, and improves the organoleptic characteristics of the product, with the cookie texture becoming crisp or softer rather than hard or sandy. Also, the combination of fibers masks or eliminates undesirable aftertaste, eliminates discoloration or dark spots, and provides good cookie spread.

The high fiber molded cookies of the present invention may be produced by admixing all or a portion of the flour component, such as wheat flour, with inulin, preferably in a powder mixer, to obtain an at least substantially homogeneous preblended particulate mixture. The preblended mixture may be mixed with any remaining flour component, a resistant starch, at least one sugar, and at least one shortening or fat to obtain an at least substantially homogenous dough, followed by rotary molding the dough into pieces, and baking the pieces to obtain a rotary molded cookie.

The amount of inulin employed may be from about 10% by weight to about 90% by weight, preferably from about 25% by weight to about 75% by weight, most preferably from about 40% by weight to about 60% by weight based upon the total weight of the inulin and resistant starch. The total amount of inulin and resistant starch employed may be at least about 10% by weight, preferably from about 12% by weight to about 25% by weight, most preferably from about 13% by weight to about 20% by weight, based upon the weight of the wheat flour.

The rotary molded cookies of the present invention may have a fiber content derived from the inulin and resistant starch of at least about 7% by weight, preferably at least about 8% by weight, based upon the weight of the rotary molded cookie. The fiber content is at least substantially homogeneously dispersed throughout the cookie, rather than being present in lumps or included in large amounts in a topping, such as icing, which may include high amounts of shortening or fat and sugar. The shortening or fat content of the cookie may be less than about 14% by weight, based upon the weight of the rotary molded cookie, and the calorie content of the cookie may be less than about 433 Kcal per 100 g of the rotary molded cookie. The rotary molded cookie may be molded in a variety of shapes. In preferred embodiments, the rotary molded cookie may be in the form of a human face, human body, animal face, and animal body. Each body piece and each face piece may have a portion for matching a face piece with a body piece, so that when the body portion and face portion are put together, a complete figure is obtained as with puzzle pieces.

### DETAILED DESCRIPTION OF THE INVENTION

The present invention provides a process for eliminating lump formation and improving molding performance in the production of high fiber content cookies containing inulin. Cookies produced in accordance with the present invention exhibit excellent cookie spread, homogeneity in color and texture, with no starchy aftertaste or undesirable dark spots, and a exhibit a crisp, not hard and not too soft texture.

High fiber cookies containing inulin are mass produced using rotary molding to achieve a variety of shapes while avoiding inulin lumping and excessive dough stickiness and mold release problems by replacing a substantial portion of the inulin with a resistant starch. Even though the inulin is replaced, the fiber content of the cookie is still high because resistant starch is a good source of fiber. Cookies baked from high fiber doughs obtained in accordance with the present invention may have a fiber content derived from the inulin and resistant starch of at least about 7% by weight, preferably at least about 8% by weight, based upon the weight of the rotary molded cookie. The rotary molded cookies possess distinct, clear shape definition and sharp, well-defined embossing and imprinting with excellent cookie spread comparable to that obtained with conventional rotary molded cookies which do not have high fiber contents. The high fiber rotary molded cookies exhibit at least substantial homogeneity in color and texture and are at least substantially devoid of undesirable dark spots caused by insufficient dispersion or lumping of inulin. The resistant starch masks the aftertaste of inulin, and the inulin masks the starchy aftertaste of resistant starch. Softening of the hard texture provided by large amounts of inulin is achieved by employing resistant starch in amounts which provide a softer, but crisp texture. Calorie reduction, shortening or fat content, and sugar content reduction may also be achieved with the combination of inulin and resistant starch. The increase in fiber content while improving nutritional value and achieving calorie reduction in a rotary molded cookie having shapes with play value provides an attractive and healthier product for children.

The method used for the determination of the fiber content may be the Prosky method for Total Dietary Fiber in Foods set forth in AOAC, J. Assoc. Anal. Chem., 68(2) p. 399 (1985) and AOAC, Official Methods of Analysis, J. Assoc. Anal. Chem. 15th ed., pp. 1105-1106 (1990). The AOAC method for Total Dietary Fiber in Foods involves: a) treatment with 0.1 ml α-amylase, Sigma Chemical Co., followed by b) treatment with 5 mg protease, Sigma Chemical Co., then treatment with 0.3 ml amyloglucosidase, Sigma Chemical Co., d) precipitation of soluble fiber by ethanol, and e) filtering and drying. Another, more stringent method for determining dietary fiber content which may also be used is disclosed in Example 1B of U.S. Pat. No. 6,013,299 to Haynes et al, the disclosure of which is herein incorporated by reference in its entirety. The Haynes et al method is adopted and modified from the Prosky method for Total Dietary Fiber in Foods set forth in AOAC. The Haynes et al adopted method is more stringent, involving higher amounts of enzymes and freeze drying, and results in lower values for the yield of resistant starch.

Inulin employed in the present invention is a well known β-2-fructofuranose material long used as a food supplement and a staple of commerce. It is a carbohydrate material derived from a variety of crops importantly from Jerusalem artichoke and chicory. Inulin is a prebiotic, that is, a food material that is metabolized in the intestine by desirable bacteria such as bifidus and lactobacillus.

Generally, inulin is the clean, dried fibrous material which is separated by extraction from, for example, chicory, onions and Jerusalem artichokes and other common plant sources. Inulin is available in various commercial grade varieties. Pure inulin is commercially available from, for example, Rhone-Poulenc in the U.S. under the trade name RAFTILINE® and from Imperial Suicker Unie, LLC in Europe. Pure inulin has an average degree of polymerization (“DP”) of about 9 to 10. Raftiline, available in powder form, is obtained from chicory roots and is a mixture of GFₙ. molecules where: G=glucose, F=fructose, and n=number of fructose units linked and ranges from about two to more than 50.

Another commercial source of inulin which may be employed in the present invention is Beneo® inulin, manufactured by Orafti Group, Belgium. Beneo® inulin is a white, odorless, soluble powder with a slightly sweet taste and no aftertaste. It is a mixture of oligo- and polysaccharides which are composed of fructose units connected by beta (2-1) links. Almost every molecule is terminated by a glucose unit. The total number of fructose or glucose units (Degree of Polymerization or DP) of chicory inulin ranges mainly between 2 and 60.

Less preferred for use herein are less pure inulin source materials such as dried Jerusalem artichoke flour, deflavored onion flour and mixtures thereof.

The resistant starch employed in the present invention may be any commercially available or known compositions comprising enzyme resistant starch (RS) type I, II, III, or IV, or mixtures thereof. Exemplary of resistant starches which may be employed are high melting RS III type starches and heat treated RS type I, II, or IV type starches disclosed in U.S. Pat. No. 6,013,299 to Haynes et al, the disclosure of which is herein incorporated by reference in its entirety. Exemplary commercially available, enzyme resistant starch compositions which may be used in the present invention are Hi-Maize 240, formerly Novelose 240, which is an enzyme resistant granular starch (an RS type III ingredient), Novelose 330 which is an enzyme resistant retrograded starch (an RS type III ingredient, non-granular retrograded starch), and Hi-maize 260, formerly Novelose 260, which is a granular resistant starch, each produced by National Starch and Chemical Co., Bridgewater, N.J., and Crystalean which is a retrograded starch produced by Opta food Ingredients, Inc., Cambridge, Mass. Novelose 330 may have a moisture content of about 7% by weight, a resistant starch content of about 25% by the method of Example 1B of U.S. Pat. No. 6,013,299 to Haynes et al, and a dietary fiber content by the less stringent AOAC method of about 33%. Hi-maize 260 is a granular resistant starch which contains 60% total dietary fiber (TDF) as measured by AOAC Method 991.43. Hi-maize 240 is a granular resistant starch which contributes 40% Total Dietary Fiber when analyzed using the AOAC method for fiber analysis. Hi-maize 260 is a preferred commercially available resistant starch for use in the rotary molded cookies of the present invention.

In embodiments of the invention, a very high melting enzyme resistant starch type III, disclosed in U.S. Pat. No. 6,013,299 to Haynes et al which may be employed may have an endothermic melting peak of at least 140° C., preferably at least 145° C., most preferably at least about 150° C., as determined by modulated differential scanning calorimetry (MDSC). The very-high-melting, enzyme-resistant starch component is substantially unaltered by baking, that is, it remains substantially enzyme resistant and exhibits a reduced caloric value of less than about 0.5 Kcalories/gram (100% by weight RS type III, having a melting point or endothermic peak temperature of at least 140° C.), as determined by fiber analysis after baking. Enthalpy values for the isolated high-melting enzyme-resistant starch may range from greater than about 5 Joules/g, preferably from about 8 Joules/g to about 15 Joules/g, at a temperature of from 130° C. to about 160° C. Bulking agents or flour substitutes containing the very-high-melting RS type III starch which are disclosed in U.S. Pat. No. 6,013,299 to Haynes et al may also be employed in the cookies of the present invention.

The amount of inulin employed may be from about 10% by weight to about 90% by weight, preferably from about 25% by weight to about 75% by weight, most preferably from about 40% by weight to about 60% by weight based upon the total weight of the inulin and resistant starch. Use of only inulin or lower amounts of resistant starch as a source of fiber, was found to result in dispersion problems during mixing to form a dough. Dispersion of the fibers becomes difficult due to the hygroscopic properties of the fiber and the large amount of the fibers, resulting in lump formation. Also, the doughs tend to become too sticky and moldability decreases if the amount of resistant starch is too low. In addition, cookies produced with only inulin or too little resistant starch have been found to present a slightly undesirable aftertaste, a harder texture and a bit too dark in color. Although the resistant starch improves organoleptic and molding properties, it has been found that as the amount of resistant starch used to replace the inulin increases, the cookie texture tends to become too soft, and the cookie flavor tends to become too starchy providing a starchy aftertaste.

To achieve the high fiber contents for the rotary molded cookies of the present invention, the total amount of inulin and resistant starch employed may be at least about 10% by weight, preferably from about 12% by weight to about 25% by weight, most preferably from about 13% by weight to about 20% by weight, based upon the weight of the flour component or farinaceous material, such as wheat flour.

The flour component or farinaceous materials which may be combined with the inulin and resistant starch ingredients in producing the high fiber cookie doughs and cookies of the present invention may be any comminuted cereal grain or edible seed or vegetable meal, derivatives thereof and mixtures thereof. Exemplary of the flour component or farinaceous materials which may be used are wheat flour, corn flour, corn masa flour, oat flour, barley flour, rye flour, rice flour, potato flour, grain sorghum flour, tapioca flour, graham flour, or starches, such as corn starch, wheat starch, rice starch, potato starch, tapioca starch, physically and/or chemically modified flours or starches, such as pregelatinized starches, and mixtures thereof. The flour may be bleached or unbleached. Wheat flour or mixtures of wheat flour with other grain flours are preferred.

The total amount of the flour component, such as wheat flour, used in the compositions of the present invention may range, for example, from about 20% by weight to about 80% by weight, preferably from about 45% by weight to about 75% by weight, based upon the weight of the dough. Unless otherwise indicated, all weight percentages are based upon the total weight of all ingredients forming the doughs or formulations of the present invention, except for inclusions such as flavor chips, nuts, raisins, and the like. Thus, “the weight of the dough” does not include the weight of inclusions.

The flour component may be replaced in part by conventional flour substitutes or bulking agents, such as polydextrose, hollocellulose, microcrystalline cellulose, mixtures thereof, and the like in amounts which do not adversely affect moldability, cookie texture, and cookie spread. Corn bran, wheat bran, oat bran, rice bran, mixtures thereof, and the like may also be substituted in part for the flour component to enhance color, or to affect texture.

Process-compatible ingredients, which can be used to modify the texture of the products produced in the present invention, include sugars such as sucrose, fructose, lactose, dextrose, galactose, maltodextrins, corn syrup solids, hydrogenated starch hydrolysates, protein hydrolysates, glucose syrup, mixtures thereof, and the like. Reducing sugars, such as fructose, maltose, lactose, and dextrose, or mixtures of reducing sugars may be used to promote browning. Fructose is the preferred reducing sugar, because of its ready availability and its generally more enhanced browning and flavor-development effects. Exemplary sources of fructose include invert syrup, high fructose corn syrup, molasses, brown sugar, maple syrup, mixtures thereof, and the like.

The texturizing ingredient, such as sugar, may be admixed with the other ingredients in either solid or crystalline form, such as crystalline or granulated sucrose, granulated brown sugar, or crystalline fructose, or in liquid form, such as sucrose syrup or high fructose corn syrup. In embodiments of the invention, humectant sugars, such as high fructose corn syrup, maltose, sorbose, galactose, corn syrup, glucose syrup, invert syrup, honey, molasses, fructose, lactose, dextrose, and mixtures thereof, may be used to promote chewiness in the baked product.

In addition to the humectant sugars, other humectants, or aqueous solutions of humectants which are not sugars or possess a low degree of sweetness relative to sucrose, may also be employed in the dough or batter. For example, glycerol, sugar alcohols such as mannitol, maltitol, xylitol and sorbitol, and other polyols, may be used as humectants. Additional examples of humectant polyols (i.e. polyhydric alcohols) include glycols, for example propylene glycol, and hydrogenated glucose syrups. Other humectants include sugar esters, dextrins, hydrogenated starch hydrolysates, and other starch hydrolysis products.

In embodiments of the present invention, the total sugar solids content, or the texturizing ingredient content, of the doughs of the present invention may range from zero up to about 50% by weight, preferably from about 10% by weight to about 25% by weight, based upon the weight of the dough.

The sugar solids may be replaced in whole or in part by a conventional sugar substitute or conventional bulking agent such as polydextrose, hollocellulose, microcrystalline cellulose, mixtures thereof, and the like, in amounts which do not adversely affect moldability, cookie texture, and cookie spread. Polydextrose is a preferred sugar substitute or bulking agent for making the reduced calorie baked goods of the present invention. Exemplary replacement amounts may be at least about 10% by weight, for example from about 15% by weight to about 25% by weight, of the original sugar solids content.

In embodiments of the invention, the amount of the conventional sugar substitute, conventional bulking agent, or conventional flour substitute, preferably polydextrose, may be from about 3% by weight to about 15% by weight, based upon the weight of the dough. Exemplary of a commercially available polydextrose which may be employed is Litesse II (70% by weight solution), produced by Danisco.

The moisture contents of the doughs of the present invention should be sufficient to provide the desired consistency to enable proper forming, machining, and molding of the dough. The total moisture content of the doughs of the present invention will include any water included as a separately added ingredient, as well as the moisture provided by flour (which usually contains about 12% to about 14% by weight moisture), the moisture content of the inulin and resistant starch ingredients, and the moisture content of other dough additives included in the formulation, such as high fructose corn syrup, invert syrups, or other liquid humectants.

Taking into account all sources of moisture in the dough or batter, including separately added water, the total moisture content of the cookie doughs or batters of the present invention is generally less than about 35% by weight, preferably less than about 30% by weight, for example from about 10% by weight to about 20% by weight, based upon the weight of the dough.

Oleaginous compositions which may be used to obtain the doughs and baked goods of the present invention may include any known shortening or fat blends or compositions useful for baking applications, and they may include conventional food-grade emulsifiers. Vegetable oils, lard, marine oils, and mixtures thereof, which are fractionated, partially hydrogenated, and/or interesterified, are exemplary of the shortenings or fats which may be used in the present invention. Edible reduced- or low-calorie, partially digestible or non-digestible fats, fat-substitutes, or synthetic fats, such as sucrose polyesters or triacyl glycerides, which are process-compatible may also be used. Mixtures of hard and soft fats or shortenings and oils may be used to achieve a desired consistency or melting profile in the oleaginous composition. Exemplary of the edible triglycerides which can be used to obtain the oleaginous compositions for use in the present invention include naturally occurring triglycerides derived from vegetable sources such as soybean oil, palm kernel oil, palm oil, rapeseed oil, safflower oil, sesame oil, sunflower seed oil, and mixtures thereof. Marine and animal oils such as sardine oil, menhaden oil, babassu oil, lard, and tallow may also be used. Synthetic triglycerides, as well as natural triglycerides of fatty acids, may also be used to obtain the oleaginous composition. The fatty acids may have a chain length of from 8 to 24 carbon atoms. Solid or semi-solid shortenings or fats at room temperatures of, for example, from about 75° F. to about 10° F. may be used.

The shortening or fat content of the cookie may be less than about 14% by weight, based upon the weight of the rotary molded cookie. Baked goods which may be produced in accordance with the present invention include reduced calorie baked goods which are also reduced fat, low fat or no-fat products. As used herein, a reduced-fat food product is a product having its fat content reduced by at least 25% by weight from the standard or conventional product. A low-fat product has a fat content of less than or equal to three grams of fat per reference amount or label serving. However, for small reference amounts (that is, reference amounts of 30 grams or less or two tablespoons or less), a low-fat product has a fat content of less than or equal to 3 grams per 50 grams of product. A no-fat or zero-fat product has a fat content of less than 0.5 grams of fat per reference amount and per label serving. For cookies, the reference amount is 30 grams. Thus, the fat content of a low-fat cookie would therefore be less than or equal to 3 grams of fat per 50 grams or less than or equal to about 6% fat, based upon the total weight of the final product.

In addition to the foregoing, the doughs of the invention may include other additives conventionally employed in cookies. Such additives may include, for example, milk by-products, egg or egg by-products, cocoa, vanilla or other flavorings, as well as inclusions such as nuts, raisins, coconut, flavored chips such as chocolate chips, butterscotch chips and caramel chips, and the like in conventional amounts.

A source of protein, which is suitable for inclusion in baked goods, may be included in the doughs of the present invention to promote Maillard browning. The source of protein may include non-fat dry milk solids, dried or powdered eggs, mixtures thereof, and the like. The amount of the proteinaceous source may, for example, range up to about 5% by weight, based upon the weight of the dough.

The dough compositions of the present invention may contain up to about 5% by weight of a leavening system, based upon the weight of the dough. Exemplary of chemical leavening agents or pH-adjusting agents which may be used include alkaline materials and acidic materials such as sodium bicarbonate, ammonium bicarbonate, calcium acid phosphate, sodium acid pyrophosphate, monocalcium phosphate, diammonium phosphate, tartaric acid, mixtures thereof, and the like. Yeast may be used alone or in combination with chemical leavening agents.

The doughs of the present invention may include antimycotics or preservatives, such as calcium propionate, potassium sorbate, sorbic acid, and the like. Exemplary amounts may range up to about 1% by weight of the dough, to assure microbial shelf-stability.

Emulsifiers may be included in effective, emulsifying amounts in the doughs of the present invention. Exemplary emulsifiers which may be used include, mono- and di-glycerides, diacetyl tartaric acid ester of mono- and diglycerides, polyoxyethylene sorbitan fatty acid esters, lecithin, stearoyl lactylates, and mixtures thereof. Exemplary of the polyoxyethylene sorbitan fatty acid esters which may be used are water-soluble polysorbates such as polyoxyethylene (20) sorbitan monostearate (polysorbate 60), polyoxyethylene (20) sorbitan monooleate (polysorbate 80), and mixtures thereof. Examples of natural lecithins which may be used include those derived from plants such as soybean, rapeseed, sunflower, or corn, and those derived from animal sources such as egg yolk. Soybean-oil-derived lecithins are preferred. Exemplary of the stearoyl lactylates are alkali and alkaline-earth stearoyl lactylates such as sodium stearoyl lactylate, calcium stearoyl lactylate, and mixtures thereof. Exemplary amounts of the emulsifier which may be used range up to about 3% by weight of the dough.

Production of the doughs of the present invention may be performed using conventional mixing equipment. To help avoid lumping and to obtain at least substantially homogeneous dispersion of the inulin, the inulin ingredient may be preblended with the flour component to obtain a substantially homogeneous particulate mixture for mixing with the other dough ingredients. The inulin and the flour component may be admixed in a powder mixer, or high speed mixer which may be equipped with a chopper system and rotating vanes or paddles, such as a Speedmix High Speed Mixer Model DFML 2000, manufactured by Buehler AG, Uzwil, Switzerland, or a double cone mixer. The inulin may be admixed with all, or a portion, of the flour component, such as wheat flour, in the powder mixer to form the preblend. For example, in embodiments of the invention, 100% by weight of the total flour component content of the dough may be preblended with the inulin. In other embodiments, the inulin may be preblended with about 15% by weight to about 50% by weight of the total flour component content of the dough. The remaining portion of the flour component may be added separately during the dough-up stage of the cookie dough production process.

The doughs of the present invention may be produced using a creaming stage and a dough-up stage with mixing taking place in conventional mixing equipment used for the mass production of cookie doughs, such as in an upright or vertical mixer. In the creaming stage, the sugars, flavoring, leavening agents, and the shortening or fat may be admixed using conventional mixing times and speeds to obtain a substantially homogeneous creamed mixture. In the dough-up stage, the preblend of the inulin and flour component, the rest of the flour, and the resistant starch may be added to and mixed with the creamed mixture to obtain a substantially homogeneous dough using conventional mixing times and speeds.

The high fiber content cookie dough of the present invention may then be formed into individual pieces by a rotary molder. Commercially available rotary molders may be used in the present invention, such as those produced by Weidenmuller Co., Morton Grove, Ill. The rotary molding apparatus generally comprises a rotating feeding drum. Positioned adjacent to and in peripheral contact with the rotating feeding drum is a rotary molding die roll. The rotary molding die roll is provided with a plurality of die cups or molding cavities positioned in a particular arrangement about its peripheral surface. The die cups and respective molded dough pieces may have different shapes and different embossing or imprinting patterns, for example different human or animal body shapes and/or different head shapes.

The individual pieces may be transferred from the rotary molder to an oven. Conventional baking ovens may be used for baking the rotary molded pieces. Multi-zoned band ovens which are gas fired and are equipped with top and bottom heating means are preferred. The baking oven may be equipped with a continuous open mesh band.

While baking times and temperatures will vary for different dough or batter formulations, oven types, etc., in general, commercial cookie-baking times may range from about 2.5 minutes to about 15 minutes, and baking temperatures may range from about 250° F. (121° C.) to about 600° F. (315° C.).

The baked products of the present invention may have a relative vapor pressure (“water activity”) of less than about 0.7, preferably less than about 0.6, for preservative free microbial shelf-stability. The water content of the cookie or biscuit products of the present invention may generally have a moisture content of less than about 20% by weight, for example, from about 2% by weight to about 9% by weight for cookies, based upon the weight of the baked product, exclusive of inclusions.

The high fiber, rotary molded cookie may be molded in a variety of shapes, such as round, square, triangular, elliptical, rectangular, and preferably in the shape and design of a figure, such as a human, animal, fish, or butterfly, doll, cartoon character, car, toy, and the like. In preferred embodiments, the rotary molded cookie may be in the form of a human face, human body, animal face, and animal body. Each body piece and each face piece may have a portion for matching a face piece with a body piece, so that when the body portion and face portion are put together, a complete figure is obtained as with puzzle pieces. For example, a body piece may have an indented or concave shaped portion where a rounded face piece may fit. Different face pieces may fit or be matched with a given body piece, and vice versa, thereby providing a variety of combinations of faces and bodies to provide amusement or fun value for children, while promoting the consumption of nutritional, healthy foods.

The high fiber cookie dough or batter compositions of the present invention may be used for the production of rotary molded chocolate cookies, vanilla cookies, milk cookies, butter cookies, biscuits, chocolate chip cookies, oatmeal cookies, fruit cookies, sugar cookies, animal crackers, sandwich cookies, and the like.

The present invention is further illustrated by the following examples, where all parts, ratios, and percentages are by weight, are pressures are atmospheric pressure, and all temperatures are in ° C., unless otherwise stated:

### EXAMPLE 1

The ingredients and their relative amounts which may be used to prepare high fiber content rotary molded chocolate cookies containing inulin distributed at least substantially uniformly throughout the cookie, without lumping and dark spots and having a crisp texture and distinct, well defined embossing or imprinting in the shapes of a human body and human face or head in accordance with the present invention are:

TABLE 1
Chocolate Cookie Ingredients

| | Amount | Weight |
|---|---|---|
| INGREDIENT | (kg/batch) | % |
| Wheat Flour | 113.000 | 39.826 |
| Inulin Preblend (27 kg inulin + 100 kg wheat flour) | 50.000 | 17.622 |
| Ground Sugar, Sucrose | 40.000 | 14.098 |
| Hydrogenated Vegetable Fat | 28.000 | 9.868 |
| Water | 12.000 | 4.229 |
| Invert Sugar | 12.000 | 4.229 |
| Resistant Starch, Hi-Maize 260 (National | 11.000 | 3.877 |
| Starch & Chemical Co.) | | |
| Caramel Color | 5.800 | 2.044 |
| Cocoa Powder | 4.500 | 1.586 |
| Sodium Bicarbonate | 2.100 | 0.740 |
| Monocalcium Phosphate | 0.900 | 0.317 |
| Salt | 1.250 | 0.441 |
| Soya Lecithin | 1.220 | 0.430 |
| Ammonium Bicarbonate | 0.700 | 0.247 |
| Skimmed Milk Powder | 0.650 | 0.229 |
| Chocolate Flavor | 0.510 | 0.180 |
| Diacetyl Tartaric Acid Ester of Mono-Diglycerides | 0.070 | 0.025 |
| Vitamin Mix | 0.032 | 0.011 |
| TOTAL | 283.732 | 100.000 |

The inulin preblend may be produced by admixing Beneo® inulin, manufactured by Orafti Group, Belgium, with wheat flour in a double cone mixer to obtain a homogeneous particulate mixture. The mixing may be conducted at a mixing speed of about 20 rpm for about 30 minutes.

In the creaming stage, the sugar, caramel color, cocoa powder, sodium bicarbonate, salt, monocalcium phosphate, skimmed milk, soya lecithin, emulsifier, ammonium bicarbonate, vitamin mix, flavor, hydrogenated vegetable fat, water, and invert sugar may be added to a vertical mixer and mixed for about 4 minutes at about 35 rpm to obtain a substantially homogeneous creamed mixture.

In the dough-up stage, a portion of the wheat flour, for example about 50% by weight of the wheat flour, may be added on top of the creamed mixture in the vertical mixer. The preblend of inulin and wheat flour may then be added on top of the already added flour, followed by addition of the remaining wheat flour and then the resistant starch. All of the ingredients may be admixed for about 2.5 minutes at about 35 rpm to obtain a substantially homogeneous high fiber content cookie dough.

The cookie dough may be fed to a rotary molder and molded into individual cookie dough pieces, with about half of the pieces each having well defined embossing or imprinting in the shape of a human body, and the remaining pieces each having well defined embossing or imprinting in the shape of a human face. The human face pieces or head pieces produced by the rotary molder may have the same shape and design or a plurality of different shapes and designs from each other. Also, the human body pieces produced by the rotary molder may have the same shape and design or a plurality of different shapes and designs from each other.

The rotary molded dough pieces may be baked to a shelf-stable moisture content in a multi-zone band oven to obtain high fiber content cookies which substantially retain the well defined embossing or imprinting and the human body and human face shapes imparted to the dough pieces by the rotary molder. The dough pieces may be baked at temperatures of about 338° F. to about 482° F. for about 4 minutes to about 10 minutes to obtain the high fiber content rotary molded cookies of the present invention.

The fiber content of the cookies may be about 8.5 g fiber per 100 gram of product as determined by the AOAC method for dietary fiber analysis. The ratio of the inulin content to the resistant starch content of the cookies is about 1.0:1.04. The total inulin and resistant starch content of the cookies is about 14.2% by weight, based upon the total weight of the wheat flour. The fat content of the cookies may be about 12.7 g fat per 100 gram of product. The calorie content of the cookies may be about 409 Kcal per 100 gram of product.

The human head or face cookies and the human body cookies may each have a shape at a neck location so that any head cookie may fit together with any body cookie, like puzzle pieces, to provide a unitary-looking complete human body figure.

### EXAMPLE 2

The ingredients and their relative amounts which may be used to prepare high fiber content rotary molded milk flavored cookies containing inulin distributed at least substantially uniformly throughout the cookie, without lumping and dark spots and having a crisp texture and distinct, well defined embossing or imprinting in the shapes of a human body and human face or head in accordance with the present invention are:

TABLE 2
Milk Flavor Cookie Composition

| | Amount | Weight |
|---|---|---|
| Ingredient | (kg/batch) | % |
| Wheat Flour | 128.00 | 43.048 |
| Inulin Preblend (27 kg inulin + 100 kg wheat flour) | 50.00 | 16.816 |
| Ground Sugar, Sucrose | 45.00 | 15.134 |
| Hydrogenated Vegetable Fat | 31.00 | 10.425 |
| Water | 18.00 | 6.053 |
| Invert Sugar | 7.00 | 2.354 |
| Resistant Starch, Hi-Maize 260 (National Starch & | 11.50 | 3.867 |
| Chemical Co.) | | |
| Sodium Bicarbonate | 0.98 | 0.330 |
| Monocalcium Phosphate | 0.51 | 0.172 |
| Salt | 1.35 | 0.454 |
| Soya Lecithin | 1.33 | 0.447 |
| Ammonium Bicarbonate | 0.77 | 0.259 |
| Skimmed Milk Powder | 1.20 | 0.404 |
| Milk Flavor | 0.59 | 0.198 |
| Diacetyl Tartaric Acid Ester of Mono-Diglycerides | 0.08 | 0.027 |
| Vitamin Mix | 0.03 | 0.010 |
| TOTAL | 297.34 | 100.000 |

In the creaming stage, the sugar, sodium bicarbonate, salt, monocalcium phosphate, skimmed milk, soya lecithin, emulsifier, ammonium bicarbonate, vitamin mix, flavor, hydrogenated vegetable fat, water, and invert sugar may be added to a vertical mixer and mixed for about 4 minutes at about 35 rpm to obtain a substantially homogeneous creamed mixture.

In the dough-up stage, a portion of the wheat flour, for example about 50% by weight of the wheat flour, may be added on top of the creamed mixture in the vertical mixer. The preblend of inulin and wheat flour, prepared as in Example 1, may then be added on top of the already added flour, followed by addition of the remaining wheat flour and then the resistant starch. All of the ingredients may be admixed for about 2.5 minutes at about 35 rpm to obtain a substantially homogeneous high fiber content cookie dough.

The cookie dough may be fed to a rotary molder and molded into individual cookie dough pieces, with about half of the pieces each having well defined embossing or imprinting in the shape of a human body, and the remaining pieces each having well defined embossing or imprinting in the shape of a human face. The human face pieces or head pieces produced by the rotary molder may have the same shape and design or a plurality of different shapes and designs from each other. Also, the human body pieces produced by the rotary molder may have the same shape and design or a plurality of different shapes and designs from each other.

The rotary molded dough pieces may be baked to a shelf-stable moisture content in a multi-zone band oven to obtain high fiber content cookies which substantially retain the well defined embossing or imprinting and the human body and human face shapes imparted to the dough pieces by the rotary molder. The dough pieces may be baked at temperatures of about 338° F. to about 482° F. for about 4 minutes to about 10 minutes to obtain the high fiber content rotary molded cookies of the present invention.

The fiber content of the cookies may be about 8.5 g fiber per 100 gram of product as determined by the AOAC method for dietary fiber analysis. The ratio of the inulin content to the resistant starch content of the cookies is about 1.0:1.08. The total inulin and resistant starch content of the cookies is about 13.2% by weight, based upon the total weight of the wheat flour. The fat content of the cookies may be about 13.5 g fat per 100 gram of product. The calorie content of the cookies may be about 424 Kcal per 100 gram of product.

The human head or face cookies and the human body cookies may each have a shape at a neck location so that any head cookie may fit together with any body cookie, like puzzle pieces, to provide a unitary-looking complete human body figure.

What is claimed is:

1. A high fiber, rotary molded cookie comprising an at least substantially homogeneous mixture of:
a) wheat flour,
b) at least one sugar,
c) at least one shortening or fat,
d) inulin, and
e) a resistant starch,
the total amount of inulin and resistant starch being at least about 10% by weight based upon the weight of the wheat flour, the amount of inulin being from about 10% by weight to about 90% by weight, based upon the total weight of the inulin and resistant starch, and the fiber content of the cookie being at least about 7% by weight, based upon the weight of the rotary molded cookie.

2. A high fiber, rotary molded cookie as claimed in claim 1 wherein the amount of inulin is from about 25% by weight to about 75% by weight, based upon the total weight of the inulin and resistant starch.

3. A high fiber, rotary molded cookie as claimed in claim 1 wherein the amount of inulin is from about 40% by weight to about 60% by weight, based upon the total weight of the inulin and resistant starch.

4. A high fiber, rotary molded cookie as claimed in claim 1 wherein the total amount of inulin and resistant starch is from about 12% by weight to about 25% by weight, based upon the weight of the wheat flour.

5. A high fiber, rotary molded cookie as claimed in claim 2 wherein the total amount of inulin and resistant starch is from about 12% by weight to about 25% by weight, based upon the weight of the wheat flour.

6. A high fiber, rotary molded cookie as claimed in claim 3 wherein the total amount of inulin and resistant starch is from about 12% by weight to about 25% by weight, based upon the weight of the wheat flour.

7. A high fiber, rotary molded cookie as claimed in claim 2 wherein the shortening or fat content of the cookie is less than about 14% by weight, based upon the weight of the rotary molded cookie, and the calorie content of the cookie is less than about 433 Kcal per 100 g of the rotary molded cookie.

8. A high fiber, rotary molded cookie as claimed in claim 3 wherein the shortening or fat content of the cookie is less than about 14% by weight, based upon the weight of the rotary molded cookie, and the calorie content of the cookie is less than about 433 Kcal per 100 g of the rotary molded cookie.

9. A high fiber, rotary molded cookie as claimed in claim 1 which is molded in the form of a face or body, wherein the face cookie and the body cookie each have a shape at a neck location so that a face cookie fits together with a body cookie to provide a unitary-looking complete human body figure.

10. A method for making high fiber cookies comprising:
a) admixing wheat flour and inulin to obtain an at least substantially homogeneous preblended particulate mixture,
b) admixing the preblended mixture with a resistant starch, at least one sugar, and at least one shortening or fat to obtain an at least substantially homogenous dough, the total amount of inulin and resistant starch being at least about 10% by weight based upon the weight of the wheat flour, the amount of inulin being from about 10% by weight to about 90% by weight, based upon the total weight of the inulin and resistant starch,
c) rotary molding the dough into pieces, and
d) baking the pieces to obtain rotary molded cookies, each cookie having a fiber content of at least about 7% by weight, based upon the weight of the rotary molded cookie.

11. A method for making high fiber cookies as claimed in claim 10 wherein the wheat flour and inulin are admixed in a powder mixer.

12. A method for making high fiber cookies as claimed in claim 10 wherein the amount of inulin is from about 25% by weight to about 75% by weight, based upon the total weight of the inulin and resistant starch.

13. A method for making high fiber cookies as claimed in claim 10 wherein the amount of inulin is from about 40% by weight to about 60% by weight, based upon the total weight of the inulin and resistant starch.

14. A method for making high fiber cookies as claimed in claim 10 wherein the total amount of inulin and resistant starch is from about 12% by weight to about 25% by weight, based upon the weight of the wheat flour.

15. A method for making high fiber cookies as claimed in claim 12 wherein the total amount of inulin and resistant starch is from about 12% by weight to about 25% by weight, based upon the weight of the wheat flour.

16. A method for making high fiber cookies as claimed in claim 13 wherein the total amount of inulin and resistant starch is from about 12% by weight to about 25% by weight, based upon the weight of the wheat flour.

17. A method for making high fiber cookies as claimed in claim 12 wherein the shortening or fat content of each cookie is less than about 14% by weight, based upon the weight of the rotary molded cookie, and the calorie content of the cookie is less than about 433 Kcal per 100 g of the rotary molded cookie.

18. A method for making high fiber cookies as claimed in claim 13 wherein the shortening or fat content of each cookie is less than about 14% by weight, based upon the weight of the rotary molded cookie, and the calorie content of the cookie is less than about 433 Kcal per 100 g of the rotary molded cookie.

19. A method for making a high fiber cookie as claimed in claim 10 wherein the rotary molded cookies are in the form of a face or body, wherein the face cookie and the body cookie each have a shape at a neck location so that a face cookie fits together with a body cookie to provide a unitary-looking complete human body figure.

20. A high fiber, rotary moldable cookie dough comprising an at least substantially homogeneous mixture of:
a) wheat flour,
b) at least one sugar,
c) at least one shortening or fat,
d) inulin, and
e) a resistant starch,
the total amount of inulin and resistant starch being from about 12% by weight to about 25% by weight, based upon the weight of the wheat flour, the amount of inulin being from about 40% by weight to about 60% by weight, based upon the total weight of the inulin and resistant starch, and the rotary molded dough being bakeable to a rotary molded cookie having a fiber content of at least about 7% by weight, based upon the weight of the rotary molded cookie.
